(19) United States
(12) Patent Application Publication
(10) Pub. No.: US 2005/0147640 A1
(43) Pub. Date: Jul. 7, 2005

(54) Noctuid attractant composition

(76) Inventor: Stephen Sexton, Queensland (AU)

Correspondence Address: KNOBBE MARTENS OLSON & BEAR LLP, 2040 MAIN STREET, FOURTEENTH FLOOR, IRVINE, CA, 92614, US

(21) Appl. No.: 10/500,234

(22) PCT Filed: Dec. 23, 2002
(86) PCT No.: PCT/AU02/01765

(30) Foreign Application Priority Data
Jan. 2, 2002 (AU) PR 9788

(51) Int. Cl. A01N 25/00; A01N 25/08

(52) U.S. Cl. 424/410

(57) ABSTRACT

An attractant composition is disclosed for adult noctuid or other lepidopteran species, which comprises a mixture of about 10-45% w/w phenylacetaldehyde, 5-30% w/w anethole, 0-30% w/w 4-methoxy benzyl alcohol, and 0-30% w/w 2-methoxy benzyl alcohol.

### BACKGROUND OF THE INVENTION

1. Field of the Invention

This invention relates to a novel noctuid attractant composition and its use as an attractant for both male and female noctuids and other lepidopteran pests.

2. Description of the Prior Art

Phenylacetaldehyde has long been known as an attractant for many species of Lepidoptera and is known to be an attractive component in corn silks. (Cantelo. W. W. and Jacobson, M. Environmental Entomology 8, 444, 1979; Cantelo. W. W. and Jacobson, M. J. Environ. Sci. Health A14, 695, 1979; CRC Handbook of Natural Pesticides Volume V1 1990).

The United States Department of Agriculture conducted research on the attractancy of volatiles from flowers of the Japanese Honeysuckle. As a result U.S. Pat. No. 6,190,652 was granted which describes the use of cis-jasmone alone or in combination with other attractants including linalool and phenylacetaldehyde as an attractant for Lepidoptera.

In a more extensive study, the United States Department of Agriculture conducted experiments bioassaying a range of plant volatile compounds to determine their attractancy for Helicoverpa zea. These experiments were carried out primarily with olfactometers. This work led to the invention described in U.S. Pat. No. 6,074,634 Lopez, Jr., et al. which was granted on Jun. 13, 2000. This reference described an attractant for a range of adult Lepidopteran species which consisted of at least phenylacetaldehyde, methyl salicylate and methyl 2-methoxybenzoate and preferably 2-phenethyl alcohol and limonene.

The work leading to the advent of the present invention was done in an attempt to improve the utility of blends developed by previous workers in respect of their utility for the control of Helicoverpa armigera, a key pest in Australia and not present in USA.

### SUMMARY OF THE INVENTION

An attractant composition for adult noctuid or other lepidopteran species comprising a mixture of about 10-45% by weight phenylacetaldehyde, 5-30% and more preferably 10-20% by weight of anethole, 0-30%, more preferably 5-30% and most preferably 10-20% by weight of 2-methoxy benzyl alcohol, 0-30%, more preferably 5-30% and most preferably 10-20% by weight of 4 methoxy benzyl alcohol. There also may be provided 5-30% and most preferably 10-20% by weight of caryophyllene including beta caryophyllene, 5-30% and most preferably 10-20% of 4-methoxy-2-phenethanol, and 5-30% and most preferably 10-20% by weight of Z,3 hexenyl salicylate. The most preferred out of these optional components include the combination of 2 methoxy benzyl alcohol and 4 methoxy benzyl alcohol.

The present invention also provides methods for a reduction in noctuid and/or other lepidopteran species numbers, which includes attracting the insect species with the attractant composition. In the preferred embodiment, the attractant composition is used to pull the adult noctuid and/or other lepidopteran insects from the surrounding areas. The attractant is combined with or used in the vicinity of the food source containing an insecticide. The responding adults feed and as a result are killed.

In an alternative embodiment, the insecticide may be replaced with a pathogen such as nuclear polyhedrosis virus. In this case, the moths are not killed but their bodies become heavily contaminated and serve to distribute the virus through the crop.

Another object of the invention is to provide traps and controlled-release formulations containing the attractant composition.

A further object of the invention is to provide a method of reducing or preventing plant damage due to noctuid and/or other lepidopteran species using the attractant composition in combination with a feeding stimulant and insecticide.

The invention has certain advantages over that described in U.S. Pat. No. 6,074,634 Lopez et al. Our tests showed the attractancy of our compositions are at least not statistically significantly different to that described in the U.S. Pat. No. 6,074,634 for Helicoverpa armigera but the compounds used were generally of a higher molecular weight and lower volatility. As a consequence, the attractant blend of the preset invention has greater utility in that it is relatively easy to formulate in a manner that will release for a prolonged time. It has advantages over the blend described in U.S. Pat. No. 6,190,652 in that the ingredients are less costly.

### DETAILED DESCRIPTION OF THE INVENTION

The attractant compositions of the present invention are effective for attracting and controlling a variety of agronomically important adult insects of the order Lepidoptera. It is also envisaged that other pests of particular importance will be attracted and controlled by the compositions include which noctuids such as Helicoverpa armigera (corn earworm, cotton bollworm), Helicoverpa punctigera (native budworm), Chrysodeixus argentifera (looper) and other lepidoptera such as Leucania convecta and Spodoptera spp.

Furthermore, the attractant compositions of this invention are effective for attracting both sexes of adult Lepidoptera. Since female moths are the reproductive sex capable of laying eggs, the capture of females could serve as a major tool in reducing succeeding populations.

Suitable formulations may be prepared from these volatiles in isolated or impure form. However, as a practical matter, it is expected that substantially pure volatiles will be formulated with an inert carrier for use as an insect attractant composition. The practitioner skilled in the art will also recognize that these volatiles may be formulated in liquid or solid form. Liquid carriers for use herein include but are not limited to water or organic solvents, such as polyols, esters, low aromatic mineral oils and vegetable oils. Other carriers may include solid carriers inclusive of wood, flour and cellulose powder and absorbent polymethacrylate products such as Poly trap. Emulsions of waxes are suitable and when combined with an emulsifier provide a simple controlled release mechanism for the volatile attractants. Suitable waxes include paraffin wax and beeswax but other waxes may be equally as effective. Suitable emulsifiers include but are not limited to sorbitan monostearate, sorbitan sesquioleate, sorbitan monolaurate, sorbitan monopalmitate, cocoamine and soyaamine polyethoxylates and polyethoxylates of seartic, palmitic and oleic acids and cetyl-oleyl alcohols.

The attractant composition may be further formulated with a variety of optional components or adjuvants, including but not limited to other plant volatiles, feeding stimulants such as sucrose or invert sugar and insect toxicants.

Yet other components which may be included in the formulation include humectants, preservatives, or antimicrobial agents, thickeners, antimicrobial agents, antioxidants, emulsifiers, film forming polymers, sunlight stabilisers and mixtures thereof.

Additives which retard or slow the volatilization of the active mixture are preferred. Humectants may include polyols, sugars and glycols and more preferred humectants include glycerol, honey and sorbitol. Antioxidants which reduce polymerization of phenyl acetaldehyde are preferred and these may include butylated hydroxytoluene (BHT), butylated hydroxyanisole (BHA) and D/L alpha tocopherol (Vitamin E). Film forming polymers include gum rosin, latex, polyvinyl pyrrolidone, polyvinyl alcohol, polyvinyl chloride, polyethylene, polyvinyl acetate and mixtures thereof. Suitable thickeners include xanthan gum, hydroxycellulose gums, carageenan, tragacanth, locust bean gum and guar. Examples of suitable sunlight stabilisers are titanium oxide and zinc oxide. Additional optional additives include, shellac, methyl methacrylate, and mixtures thereof.

Preferably the attractant composition of the invention will be combined with an inert liquid or solid carrier and other components as discussed above. These other components may include from 10-50% w/w and more preferably 25% of sugar, 5-25% w/w and more preferably 10% of humectant, 0.5-3.0% w/w and more preferably 1.0% of thickener, 0.5-3.0% w/w and more preferably 1.0% of emulsifier, 2.5-15.0% w/w and more preferably 5.0% w/w of wax, 0.2-1.0% w/w and more preferably 0.5% of antioxidant when present, 0.1-1.0% w/w and more preferably 0.5% of preservative, 0.5-3.0% w/w and more preferably 1.0% of film forming polymer, 0.1-2.0% w/w of sunlight stabliser when present, and 0.1-1.0% w/w and more preferably 0.5% of shellac, methyl methacrylate or mixtures thereof when present.

In the preferred embodiment, feeding stimulants for the adult insects or moths are included in the attractant composition and function to induce the target insects to contact and/or ingest the bait. Without being limited thereto, feeding stimulants such as fructose, glucose, and particularly sucrose, are preferred. It has been found that impure sugars such as molasses, raw cane sugar and invert raw sugar are less attractive than pure white cane sugar.

Another important component of the adult control system of the present invention is inclusion 0.1-1.0% by weight of insect toxicants or pesticides that are highly toxic to the adult insects or moths, but do not significantly inhibit the attractance or feeding response when combined with a food source and applied to or in the vicinity (such as on plants or in a trap or bait station) of the crop plants treated with the feeding attractant.

Preferably the combined composition or attractant and kill composition when it contains an insect pesticide or toxicant will combine from 0.5-3% w/w and more preferably 1.0% of the attractant composition of the invention.

Insect toxicants which may be included in the attractant composition include but are not limited to insecticides such as carbaryl, methomyl, acephate, thiodicarb, malathion, chlorpyrifos, emamectin benzoate, abamectin, spinosad, endosulfan, and mixtures thereof. Bacterial and viral pathogens may also be included, as well as insect growth regulators or compounds eliciting behaviour modification or disrupting physiological functions.

Combination of the insecticide with the attractant composition of this invention and concentrated sucrose allows the use of significantly lower concentrations of insecticides to kill the adults under field conditions than would be used to control the insect pests with a normal commercial broadcast application of the same insecticides. Accordingly, one advantage of the present invention is a decrease in amount and concentration of insecticides required as compared with conventional insecticidal crop protection.

Use in this manner should prove useful in suppressing target species before they can inflict damage to agronomically important crops.

In another embodiment, the attractant composition may be included as a part of a trap or other solid support which may also contain, be a part of or be in close proximity to a feeding stimulant, and/or an insecticide, pesticide, or a mechanical component (such as a “bug zapper”), toxic or biologically active agent to eliminate, reduce, or prevent reproduction of the target insect species.

It is envisioned that the attractants may be used in conjunction with any type of appropriate trap or attractant disseminator as known in the art. The attractant can be applied or disseminated using a variety of conventional techniques, such as in an exposed solution, impregnated into a wicking material or other substrate. Further, the components of the attractant may be combined in a single dispenser provided within a single trap, or provided separately in a plurality of dispensers, all within a single trap. The attractant composition can be applied to the device undiluted, or formulated in an inert carrier. Volatilisation can be controlled or retarded by inclusion of components as described above. Controlled, slow release of the attractants over an extended period of time may also be effected by placement within vials covered with a permeable septum or cap, by encapsulation using conventional techniques, or absorption into a porous substrate.

One of ordinary skill will appreciate that the rate of release of the active ingredient mixture of the present invention from point sources in traps may be varied. This can be done by manipulation of components of the trap such as a reservoir and matrix wherein the size of the reservoir and permeability of the matrix may be varied to control the release of the attractant blend. The delivery mechanisms of the present invention preferably provides release or volatilisation of the active ingredient mixture of the invention for at least one week.

Application scenarios and methods of using the attractant composition of the present invention also include separate application of a feeding stimulant-insecticide mixture to plants by known methods with the placement of the attractant composition in a manner which will attract the noctuid and/or other lepidopteran species to the feeding stimulant-insecticide mixture. For example, an attractant feeding stimulant-insecticide mixture may be applied in parallel strips at 50 metre intervals along the rows of a crop such as cotton or sorghum. This will attract moths from the untreated rows to the rows with the attractant/feeding stimulant where they consume the insecticide and are killed. The attractant composition of the present invention may be applied in or on granules, plastic dispensers or wicks, for example, and may be applied parallel to sprays of a feeding stimulant-insecticide mixture. Cross-wind application may offer greater control of the insect population because of an increase in the area with effective volatile concentrations, and the foraging and ovipositing behaviour in which the moths fly upwind within the plant canopy. Single point application of the attractant composition may also be used effectively, depending on the existing wind conditions. Plants which may be protected from insect pests include but are not limited to agronomically important crops such as cotton and vegetables, sorghum, field corn, seed corn sweet corn, cole crops and tomatoes.

In the practice of any of the above-described embodiments, an attractant is used as a trap bait or is otherwise applied to the locus of or in the vicinity of infestation in an amount effective to attract the target insect. Factors such as population density, precipitation, temperature, wind velocity, and release rate will influence the actual number of insects trapped.

### Experimental Section

### EXAMPLE I

A useful formulation of the attractant blend is as described in Table 1:

Attractant Blend

TABLE 1

| Ingredient | Percentage w/w |
|---|---|
| Phenylacetaldehyde | 14.3 |
| 4 Methoxy 2-phenylethanol | 14.3 |
| Z,3 Hexenyl salicylate | 14.3 |
| Caryophyllene | 14.3 |
| Anethole | 14.3 |
| 2 Methoxybenzyl alcohol | 14.3 |
| 4 Methoxybenzyl alcohol | 14.3 |
| Total | 100.0 |

The attractant blend of Table 1 is mixed with other components as described in Table 2:

TABLE 2

| Ingredient | Purpose | Grams per kilogram |
|---|---|---|
| Wax | Carrier | 100.0 |
| Attractant | active ingredient | 10.0 |
| Vitamin E | Antioxidant | 1.0 |
| BHT | Antioxidant | 1.0 |
| Kemotan * | Emulsifier | 22.0 |
| Xanthan | Thickener | 0.5 |
| Sugar | feeding stimulant | 400.0 |
| Water | Extender | 464.5 |
| Total | | 1000.0 |

* sorbitan monostearate

The formulation of Table 2 is combined with water on a 1:1 volume/volume basis and a suitable amount of insecticide may be added.

The resultant dilute mixture may then be applied as a coarse spray at the rate of 10-20 litres per kilometre of row to one or two rows per 100 metres, preferably in late afternoon. Example I is included to show how a preferred composition of the invention may be formulated.

### EXAMPLE II

Comparisons of a Wide Range of Attractant Blends Using ‘Sticky Board’ Traps.

Background

Comparisons of a range of attractant blends were made using sticky board traps adjacent to cotton crops on the Darling Downs region of Queensland, Australia. This experimental set up allowed comparison of attractants in the presence of the crop volatiles without confusing factors such as the effect of non-volatile feeding stimulants.

Materials and Methods

A series of rectangular boards 1.2 metres high×1.5 metres wide were placed approximately 1 metre outside the edge of a cotton field at spacings of 50 metres. The boards were suspended at a height of 1 metre above the ground using star posts. Four 100 mm diameter round holes were made in the centre of the boards and cotton wicks containing experimental attractant mixes were suspended in these holes using a paper clip. The boards were coated on both sides with 500 to 700 grams of polybutene sticker so insects attracted to the experimental volatiles would become trapped on the boards. Impregnated wicks were placed in the traps mid afternoon and traps were checked after 48 hours.

Sticky trap Results of traps include the following:

Comparison of attractant blends using sticky traps

Comparison of moth counts in sticky traps are shown in Table 3.

TABLE 3

| | Mean | | Standard | |
|---|---|---|---|---|
| Treatment | (Moths/board)** | | Dev. | Replicates |
| No treatment | 1.19 | a | 1.60 | 16 |
| PAA | 1.00 | a | 1.00 | 9 |
| Lopez | 5.75 | c | 3.51 | 16 |
| D23 | 4.41 | bc | 3.87 | 17 |
| D24 | 3.18 | b | 2.32 | 17 |

* Total of all Noctuidae
**numbers followed by the same letter are not significantly different
P = 0.05.
Students t test.

Blend D23 and Lopez were comparable but the D 24 caught significantly fewer moths than Lopez. D24 had a significantly lower count indicating that anethole was an effective addition to the D23 blend. This means that D24 is not a composition of the invention but D23 is a composition of the invention. D24 is only included for purposes of comparison. Phenylacetaldehyde (PAA) was not significantly attractive as a sole treatment.

Table 4 refers to comparison of attractants PAA, Lopez, D23 and D24.

TABLE 4

| | Milligrams of attractant per sticky board | | | |
|---|---|---|---|---|
| Ingredients | PAA | Lopez | D23 | D24 |
| Phenylacetaldehyde | 3.12 | 3.12 | 3.12 | 3.12 |
| Caryophyllene | 0 | 0 | 3.12 | 3.12 |
| 4 methoxy 2-phenylethanol | 0 | 0 | 3.12 | 3.12 |
| 2 methoxy benzyl alcohol | 0 | 0 | 3.12 | 3.12 |
| Z,3 hexenyl salicylate | 0 | 0 | 3.12 | 3.12 |
| Anethole | 0 | 0 | 3.12 | 0 |
| Methyl salicylate | 0 | 3.12 | 0 | 0 |
| Phenylethanol | 0 | 3.12 | 0 | 0 |
| Limonene | 0 | 3.12 | 0 | 0 |
| Methyl 2-methoxybenzoate | 0 | 3.12 | 0 | 0 |

Further attractant experiments are described in Table 5 and Table 6.

TABLE 5

| | Mean | | Standard | |
|---|---|---|---|---|
| Treatment | (Moths/board)** | | Dev. | Replicates |
| No treatment | 0.929 | a | 0.997 | 14 |
| D23 | 6.750 | b | 3.337 | 16 |
| D30 | 7.438 | b | 3.52 | 16 |

*Total of all Noctuidae
**numbers followed by the same letter are not significantly different
P = 0.05.
Students t test.

TABLE 6

| | Mean | |
|---|---|---|
| Treatment | (Moths/board)** | Replicates |
| No treatment | 0 | 6 |
| D30 | 3 | 6 |
| D37 | 22 | 6 |

Blends D30 and D37 are described in Table 7 compared to blend 23.

TABLE 7

| | Milligrams of attractant per | | |
|---|---|---|---|
| | sticky board | | |
| Ingredients | D23 | D30 | D37 |
| Phenylacetaldehyde | 3.12 | 3.12 | 3.12 |
| Caryophyllene | 3.12 | 3.12 | 3.12 |
| 4 methoxy phenylethanol | 3.12 | 3.12 | 3.12 |
| 2 methoxy benzyl alcohol | 3.12 | 0 | 3.12 |
| 4 methoxy benzyl alcohol | 0 | 0 | 3.12 |
| Z,3 hexenyl salicylate | 3.12 | 3.12 | 3.12 |
| Anethole | 3.12 | 3.12 | 3.12 |

It will be noted that blend D30 was superior to blend D23 as shown in Table 5. Blend D37 was superior to D30 on the results shown in Table 6 and shows the benefit of inclusion of the preferred components 2 methoxy benzyl alcohol and 4 methoxy benzyl alcohol. Further, when the results of table 5 and table 6 are viewed together, it suggests that a substantial benefit is achieved if all the components 2 methoxy benzyl alcohol, 4 methoxy benzyl alcohol and anethole are used together.

### EXAMPLE III

Results of an Experiment in Control of Helicoverpa armigera

Location:

A mung bean field on the property of Kingsley Chapman near Oakey on the Darling Downs in Queensland, Australia.

Materials and Methods

Background

The attractant blend described above Table 9 was used in a sprayable formulation to be used in pest control in the following ways:
1) to draw adult Helicoverpa armigera to trap crops (small attractive crops grown beside the commercial crop—trap crops are mown or sprayed with an insecticide to kill the insects)
2) to draw adult Helicoverpa armigera into source crops (crops grown as sources of beneficial insects—predators and parasites of Helicoverpa armigera)
3) used as an ‘attract and kill’ product in a tank mix combination with an insecticide to draw adult Helicoverpa armigera the border of a commercial crop to control adult moths immigrating from outside sources. This has the potential to reduce drastically (to 1-2%) the amount of insecticide used to control the pest.

The simple sprayable formulation as described in Table 8 was used in a preliminary trial

TABLE 8

| Ingredient | Grams |
|---|---|
| Beeswax | 100 |
| Attractant | 5 |
| Kemotan | 20 |
| Water | 440 |
| Sugar | 440 |
| Total | 1005 |

100 grams of beeswax was melted with 20 grams of sorbitan monostearate (emulsifier) and mixed until homogenous. 5 grams of the attractant mix is added to the wax emulsifier mixture and mixed until homogenous. The water was then added to form a wax in water emulsion. Finally, the sugar was added and mixed vigorously in a blender to give a the final formulation.

The above formulation was prepared using the attractant mixture listed in Table 9.

TABLE 9

| Ingredient | % w/w |
|---|---|
| Phenylacetaldehyde | 16.7 |
| Caryophyllene | 16.7 |
| 2-Methoxybenzyl alcohol | 16.7 |
| Anethole | 16.7 |
| Z,3 Hexenyl salicylate | 16.7 |
| 4-Methoxy 2 phenethyl alcohol | 16.7 |

1 litre of water was added to an equal volume litres of the above liquid to thin the attractant mix.

6.25 grams of 80% Carbaryl was added to the mixture and mixed thoroughly.

A mixture identical to the above but lacking any volatile attractant (other than those inadvertently present in raw beeswax) served as a control.

One litre of the resultant mixtures were applied as a coarse spray onto 4 rows×50 metres of Mung beans which were known to support a high level of infestation of Helicoverpa armigera.

Adult Helicoverpa armigera killed by the treatment were collected from the treated and adjoining rows were collected and recorded one hour and 20 hours after application. The results of the experiment are shown in Table 10.

TABLE 10
Helicoverpa armigera killed using the attract
and kill formulation described above.

| Time after | Helicoverpa armigera | | | | | |
|---|---|---|---|---|---|---|
| application | Treatment | | | Control | | |
| (hours) | Males | Females | Total | Males | Females | Total |
| 1 | 56 | 11 | 67 | 5 | 2 | 7 |
| 20 | 1505 | 536 | 2049 | 686 | 265 | 951 |

When the experimental site was visited, a large flock of crows was observed to rise from the treatment area. The birds then moved in smaller numbers to the control area. It is likely that a significant proportion of the moths in both test and control areas were consumed by birds prior to the evaluation of the trial.

The trial site had a very high population of Helicoverpa armigera moths. A significant number would have encountered the feeding stimulant by random movement. For this reason, the number in the control would be expected to be high after 20 hours.

Despite the limitations of this test, the results strongly support the following:
1 A sugar based ‘attract and kill’ product in combination with a common insecticide is capable of killing large numbers of the target pest, Helicoverpa armigera
2 The presence of the novel attractants in the ‘attract and kill’ product is likely to significantly enhance the effectiveness of the product.

### EXAMPLE IV

Results of an Experiment in Control of Helicoverpa armigera

Location:

A row of sorghum adjoining an irrigated cotton field on the property of Lyn Brazil near Milmerran on the Darling Downs in Queensland, Australia.

Materials and Methods

Background

The attractant blend and carrier described above Tables 8 and 9 were used in a replicated trial in a experiment with very low populations of Helicoverpa armigera.

1 litre of water was added to an equal volume litres of the above liquid to thin the attractant mix.

6.25 grams of 80% Carbaryl was added to the mixture and mixed thoroughly.

A mixture identical to the above but lacking any volatile attractant (other than those inadvertently present in raw beeswax) served as a control.

One litre of the resultant mixtures were applied as a coarse spray onto 1 rows×50 metres×4 replicates of sorghum which were known to support a low level of infestation of Helicoverpa armigera.

Adult Helicoverpa armigera killed by the treatment were collected from the treated and adjoining rows were collected and recorded and 14 hours after application. The results of the experiment are shown in Table 11.

TABLE 11
Helicoverpa armigera killed using the attract
and kill formulation described above.
Helicoverpa armigera

| Treatment | Control |
|---|---|
| 17a | 5b |

**numbers followed by the same letter are not significantly different
P = 0.05.
Students t test.

Despite the limitations of low insect pressure, the results confirmed that the observations made in the unreplicated trial reported in Example III could be repeated and that the attractants made a significant difference to the control achieved.

### EXAMPLE V

Results of an Experiment in Control of Helicoverpa armigera

Location:

A dry land cotton field on the property of Geoff Bidstrup near Jimbour on the Darling Downs in Queensland, Australia.

Background

The attractant blend was identical to that described in above Table 9 The carrier was identical except that paraffin wax (mp 60° c.) was substituted for beeswax. The toxicant and method of application were identical to that described in Example III.

One litre of the attractant/feeding stimulant mixture was applied as a coarse spray onto 1 rows×50 metres×3 replicates of cotton which were known to support a moderate level of infestation of Helicoverpa armigera. 20 rows×50 metres on one side of each treated row were searched dear bodies.

Adult Helicoverpa armigera killed by the treatment were collected from the treated and adjoining rows were collected and recorded at 14, 38, 62 and 86 hours after application. The results of the experiment are shown in Tables 12, 13 and 14.

An attempt was made to assess the impact of the treatment on the overall population of the field. This could not be done directly as the field was 40 hectares in size and only a small part was treated. The highly mobile Helicoverpa armigera moths quickly replaced those moths killed. Instead, an estimate was made of the population of moths present per hectare. This was done by flushing the moths from 6×100 metre lengths of row within the crop at daily intervals. This together with count of moths killed per 100 metres of row allowed the level of infestation of adult Helicoverpa armigera to be assessed.

Dead moths were counted under the treated rows and along 5 adjoining rows. With adjustments for underestimation of moth kill, it was possible to estimate the moth kill and the likely impact of the treatment in the event that a whole field was treated.

TABLE 12
Estimates of moth populations on two consectuative days post
treatment Geoff Bidstrup's property, Jimbour February 2002

| | Moths/100 metre of row | | | | | | |
|---|---|---|---|---|---|---|---|
| Transect | 1 | 2 | 3 | 4 | 5 | 6 | Mean |
| Day 1 | 21 | 25 | 21 | 21 | 18 | 10 | 19.3 |
| Day 2 | 11 | 23 | 23 | 18 | 18 | 9 | 17.0 |
| mean | 16.0 | 14.0 | 22.0 | 19.5 | 18.0 | 9.5 | 18.2 |

From this data it was possible to estimate the population to be 18.2 Helicoverpa armigera moths per 100 metres of row. Assuming a 90% efficiency in flushing moths, and 66 rows per hectare, the population was 1320 moths per hectare.

TABLE 13
Estimates of moth kill

Moths killed per hectare

| Replicate | 1 | 2 | 3 | Mean |
|---|---|---|---|---|
| Day 1 | 360 | 924 | 612 | 632 |
| Day 2 | 1128 | 1032 | 972 | 1044 |
| Day 3 | 540 | 564 | 876 | 660 |

From these figures, it is possible to estimate the likely effect of treatment of large fields

TABLE 14
Estimates of the proportion of the population
killed in total field treatments

Estimated % population killed*

| Search efficiency | 50% | 75% |
|---|---|---|
| Day 1 | 68 | 46 |
| Day 2 | 100 | 100 |
| Day 3 | 100 | 66 |

*Assumes two rows treated per hectare

This trial demonstrated that the attractant/feeding stimulant/toxicant remained efficacious for the period of the test and is likely to have a significant impact on the population of moths present in the field if whole field treatments were applied.

1. An attractant composition for adult noctuid or other lepidopteran species comprising a mixture of about 10-45% w/w phenylacetaldehyde, 5-30% w/w anethole, 0-30% w/w 4-methoxy benzyl alcohol, and 0-30% w/w 2-methoxy benzyl alcohol.

2. An attractant composition as claimed in claim 1 further including 5-30% w/w of caryophyllene including beta caryophyllene.

3. An attractant composition as claimed in claim 1 further including 5-30% w/w of 4-methoxy-2-phenethanol.

4. An attractant composition as claimed in claim 1 further including 5-30% w/w of Z, 3 hexenyl salicylate.

5. An attractant composition as claimed in claim 1 further including 10-20% w/w of anethole.

6. An attractant composition as claimed in claim 1 further including 10-20% w/w of 4-methoxy benzyl alcohol.

7. An attractant composition as claimed in claim 1 further including 10-20% w/w of 2-methoxy benzyl alcohol.

8. An attractant composition as claimed in claim 2 including 10-20% w/w of caryophyllene.

9. An attractant composition as claimed in claim 3 including 10-20% w/w of 4-methoxy phenethanol.

10. An attractant composition as claimed in claim 4 including 10-20% w/w of Z,3 hexenyl salicylate.

11. An attractant and kill composition for adult noctuid or other lepidopteran species including 0.5-3.0% w/w attractant composition of claim 1, further comprising 0 1.0% of a pesticide and the remainder of the attractant and kill composition comprising other components including a liquid or solid carrier.

12. An attractant and kill composition as claimed in claim 11 including 10-50% w/w of sugar.

13. The attractant and kill composition as claimed in claim 11 further comprising 5-25% w/w of humectant.

14. The attractant and kill composition as claimed in claim 11 further comprising 0.5-3.0% w/w of thickener.

15. The attractant and kill composition as claimed in claim 11 further comprising 0.5-3.0% w/w of emulsifier.

16. The attractant and kill composition as claimed in claim 11 further comprising 0.2-1.0% w/w of antioxidant.

17. The attractant and kill composition as claimed in claim 11 further comprising 0 1.0% w/w of preservative.

18. The attractant and kill composition as claimed in claim 11 further comprising 0.5-3.0% w/w film forming polymers.

19. The attractant and kill composition as claimed in claim 11 further comprising 0.1-2.0% w/w of sunlight stabiliser.

20. The attractant and kill composition as claimed in claim 12 or 13 including 0 1.0% of shellac, methyl methacrylate or mixtures thereof.

21. The attractant and kill composition as claimed in claim 11, further comprising 2.5-15.0% w/w of wax.

22. The attractant and kill composition as claimed in claim 11 further comprising a liquid carrier.
